(19) United States
(12) Patent Application Publication
(10) Pub. No.: US 2020/0320453 A1
(43) Pub. Date: Oct. 8, 2020

(54) UPDATED MEETING ROOM RESERVATION

(71) Applicant: DSP GROUP LTD., Herzliya (IL)

(72) Inventors: Avi Keren, Herzeliya (IL); Yossi Eliyaho, Herzeliya (IL)

(21) Appl. No.: 16/278,732

(22) Filed: Feb. 19, 2019

(51) Int. Cl. G06Q 10/06; G06Q 10/10; G06Q 10/02; G06F 16/23; G10L 25/48

(52) U.S. Cl. CPC G06Q 10/06314; G06Q 10/1095; G10L 25/48; G06F 16/23; G06Q 10/02

(57) ABSTRACT

A method for determining an occupancy of a meeting room, the method may include receiving or determining, by a computerized system, an allocation of the meeting room to a meeting during a time period; checking whether audio feedback regarding an actual usage of the meeting room was received at a beginning of the time period; determining an actual usage of the meeting room based on a reception of the audio feedback or a lack of reception of the audio feedback; and updating a database and multiple user devices regarding the actual usage of the meeting room.

### CROSS REFERENCE

This application claims priority from U.S. provisional patent Ser. No. 62/632,441 filing date Feb. 20, 2018.

### BACKGROUND OF THE INVENTION

Meeting rooms such as company meeting room are usually booked in advance. In many cases, a room is booked in advance—but is not actually used. Users that did not book a meeting room may need the unused meeting room—but are not aware of the availability of the meeting room. Manually looking for booked but available meeting rooms is problematic—and the unused meeting rooms are usually lest unused.

There is a growing need to improve the utilization of vacant meeting rooms.

### SUMMARY

There may be provided a method for determining an occupancy of a meeting room, the method may include receiving or determining, by a computerized system, an allocation of the meeting room to a meeting during a time period; checking whether audio feedback regarding an actual usage of the meeting room was received at a beginning of the time period; determining an actual usage of the meeting room based on a reception of the audio feedback or a lack of reception of the audio feedback; and updating a database and multiple user devices regarding the actual usage of the meeting room.

The audio feedback may be a keyword.

The method may include determining a source of audio feedback and ignoring audio feedback originated outside the meeting room.

The method may include performing at least one iteration of requesting the audio feedback from a meeting initiator, when not receiving the audio feedback at a beginning of the time period.

The method may include performing up to a certain number of iteration of requesting the audio feedback, when not receiving the audio feedback; and marking the meeting as cancelled after a failure to receive the audio feedback during the certain number of iterations.

The method may include setting at least one of a time difference between consecutive iterations and the certain number based on a number of persons invited to the meeting.

The method may include setting at least one of a time difference between consecutive iterations and the certain number based on a priority of persons invited to the meeting.

The method may include setting at least one of a time difference between consecutive iterations and the certain number based on history of previous meeting room allocations by a meeting initiator that reserved the meeting.

The method may include setting at least one of a time difference between consecutive iterations and the certain number based on history of previous meeting room allocations by a meeting initiator that reserved the meeting.

The method may include setting at least one of a time difference between consecutive iterations and the certain number based on an existence or a lack of an existence of a gap between the meeting and a next meeting scheduled in the meeting room.

There may be provided a computer program product that may store instructions that once executed by a computerized system cause the computerized system to perform the steps of: receiving or determining, by a computerized system, an allocation of a meeting room to a meeting during a time period; checking whether audio feedback regarding an actual usage of the meeting room was received at a beginning of the time period; determining an actual usage of the meeting room based on a reception of the audio feedback or a lack of reception of the audio feedback; and updating a database and multiple user devices regarding the actual usage of the meeting room.

The computer program product is non-transitory.

The audio feedback may be a keyword.

The computer program product may store instructions for determining a source of audio feedback and ignoring audio feedback originated outside the meeting room.

The computer program product may store instructions for performing at least one iteration of requesting the audio feedback from a meeting initiator, when not receiving the audio feedback at a beginning of the time period.

The computer program product may store instructions for performing up to a certain number of iteration of requesting the audio feedback, when not receiving the audio feedback; and marking the meeting as cancelled after a failure to receive the audio feedback during the certain number of iterations.

The computer program product may store instructions for setting at least one of a time difference between consecutive iterations and the certain number based on a number of persons invited to the meeting.

The computer program product may store instructions for setting at least one of a time difference between consecutive iterations and the certain number based on a priority of persons invited to the meeting.

The computer program product may store instructions for setting at least one of a time difference between consecutive iterations and the certain number based on history of previous meeting room allocations by a meeting initiator that reserved the meeting.

The computer program product may store instructions for setting at least one of a time difference between consecutive iterations and the certain number based on history of previous meeting room allocations by a meeting initiator that reserved the meeting.

The computer program product may store instructions for setting at least one of a time difference between consecutive iterations and the certain number based on an existence or a lack of an existence of a gap between the meeting and a next meeting scheduled in the meeting room.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates an example of a method;

FIG. 2 illustrates an example of a method;

FIGS. 3 and 4 illustrate examples of methods;

FIG. 5 illustrates an example of meeting rooms, various devices, a network and a system; and

FIG. 6 illustrates an example of meeting rooms, various devices, a network and a system.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

There may be provided a system, a method and a computer program product that is non-transitory for updated meeting room reservation.

The method is highly efficient and cost effective because is may not require dedicated sensors and/or computers and may be based on computerized systems and/or devices that already exits and are used for other tasks.

The system, method and computer program product may evaluate the actual usage of a meeting room by searching, within one or more time frames, for audio information (also referred to as audio signals) that is indicative that the meeting room is being actually used.

The audio information may be one or more predefined key words, or other audio signals that indicate that the meeting room is being used.

For example, if speech is detected within the meeting room then it may be deemed occupied.

Yet for another example, a meeting room may be deemed occupied if the strength of audio signals (or strength of audio signals within certain frequency bands) exceeds a threshold. The threshold may be fixed or dynamic-based on expected or actual noise attributes.

Yet for a further example—the system may use audio signals obtained from outside a meeting room as a reference and/or from other meeting rooms to determine whether the audio signals detected in a certain meeting room are not generated in the meeting room. For example—if the audio signals from a corridor or any location outside the meeting room have the same content but are stronger than the audio signals of the meeting room—then the audio signals originate outside the meeting room—and the meeting room may be vacant.

The system may include the devices that sense the audio signals—but may not include these devices and may receive audio signals sensed by these devices.

The devices that are used to sense the audio signals in meeting rooms may be fixed, may be mobile, may belong to the meeting rooms or may belong to a user.

The devices may include, for example, mobile communication devices (such as but not limited to smartphones), teleconference devices, microphones, and the like.

The devices may communicate directly or indirectly with the computerized system using any type of combination of communication links such as wireless links (cellular, ZigbEE, Wi-Fi, and the like), wired links and the like.

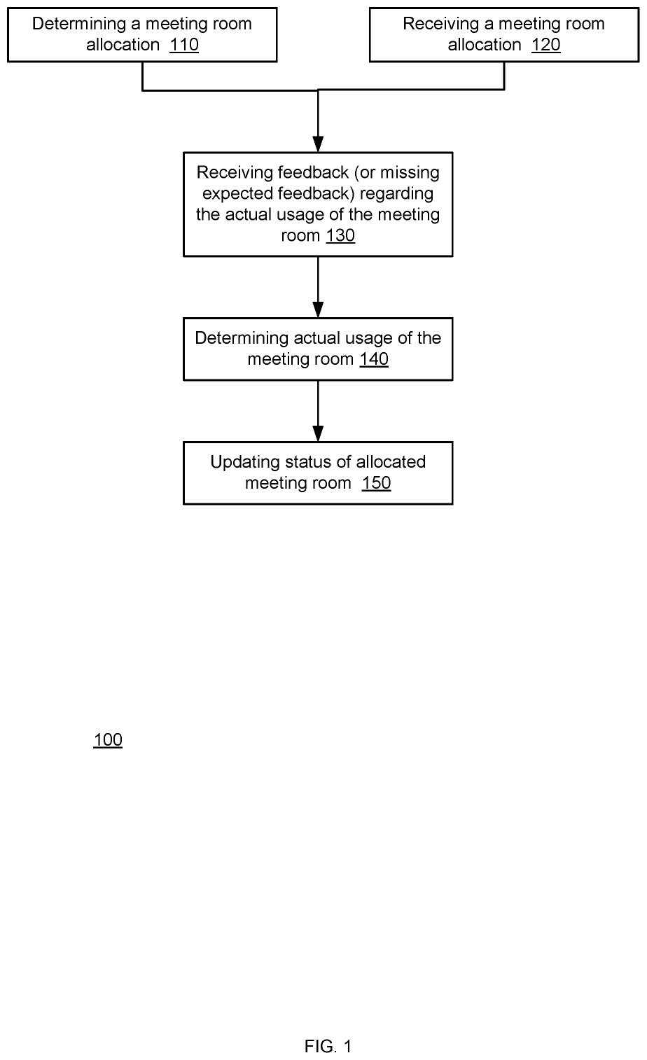

FIG. 1 illustrates an example of method 100.

Method 100 may be executed by a computerized system. The computerized system may include one or more hardware processors and may include communication modules, sensors, memory units, and the like.

Method 100 refers to a single meeting room. It is applicable to multiple meeting rooms.

Method 100 may start by steps 110 or step 120.

Step 110 may include determining a meeting room allocation. The allocation may be determined based on user requests to allocate meeting rooms. An example of such an allocation process is the Microsoft based Outlook meeting room function.

Step 120 may include receiving the meeting room allocations.

Steps 110 and 120 may be followed by step 130 of receiving feedback or missing expected feedback regarding the actual usage of the meeting room.

The feedback may include the audio information (also referred to as audio signals) that is indicative that the meeting room is being actually used.

Step 130 may constantly search for the audio information- or may perform the search within one or more time windows. The one or more time windows may be set in any manner—for example during (or proximate to) an expected beginning of a meeting for which the conference room was booked.

The one or more time windows may start, for example, 1, 2, 3, 4, 5, 6, minutes (and the like) from the beginning of the meeting.

A missing of an expected feedback may include not receiving an expected keyword within the one or more time windows or otherwise not receiving any speech signal or audio signals from the meeting room.

Step 130 may be followed by step 140 of determining actual usage of the meeting room. The determining is based on the reception of the feedback or the missing of the expected feedback.

Step 140 may be followed by step 150 of updating the status of the meeting room—busy or vacant. The update may include updating any unit, system or software that is responsible for the allocation of meeting rooms, updating users (for example—predefined users, users that previously requested to allocate the meeting room, users that are included in a waiting list, and the like) about the occupancy of the meeting room. It should be noted that users may be notified in any case, only when a booked meeting room is actually vacant, and the like.

The updating may take any form—and a user may be informed in any manner—text message, multimedia message, audio notification, visual notification, vibration, Whattsup message, SMS message, email, and the like.

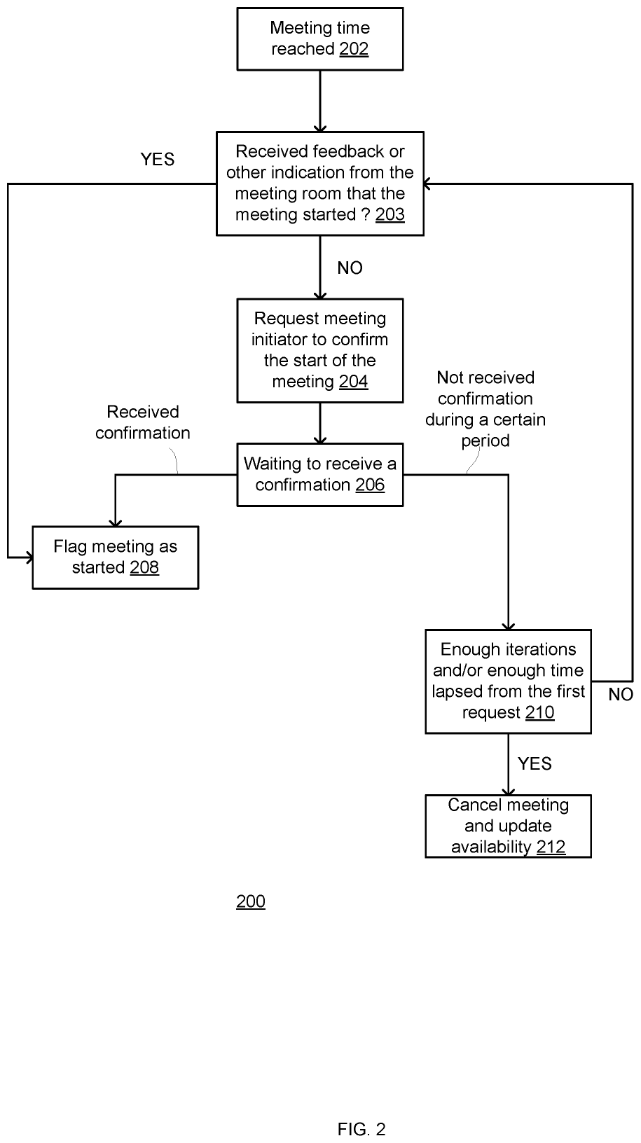

FIG. 2 illustrates an example of method 200.

Method 200 may be executed by a system that is a computerized system. The computerized system may include one or more hardware processors and may include communication modules, memory units, and the like.

Method 200 refers to a single meeting room. It is applicable to multiple meeting rooms.

Method 200 may start by step 202 of determining that a meeting should begin—meeting time reached.

Step 202 may be followed by step 203 of checking if there is an indication that the meeting begun—check whether the computerized system received feedback or other indication from the meeting room that the meeting started.

If yes—jumping to step 208 of flagging the meeting as started. This may include indicating the the meeting room is occupied by the scheduled meeting.

If no—jumping to step 204 of requesting a meeting initiator (person that reserved the meeting room—or otherwise listed as the meeting initiator) to conform the start of the meeting. This may include calling the meeting initiator and waiting to receive a keyword from the person.

Step 204 may be followed by step 206 of waiting to receive a confirmation 206—for a certain time period. The confirmation may be the audio feedback searched in step 203—for example the same keyword.

The certain period may be a fraction of the requested meeting time, a fixed period such as 1, 2, 3, 4, 5 minutes and the like. The certain period may change between one iteration of the backup process to another—for example—may be reduced between one iteration to another.

The certain period may be determined based on a reliability of the meeting initiator—which may be determined based on the number of times meeting that were ordered by the meeting initiator really occurred, the the number of times meeting that were ordered by the meeting initiator did not occur, and the like. The method may be more tolerant to more reliable meeting initiators—and may allow them more time to respond.

The certain period may be determined based on an existence (or lack of existence) of a gap between the scheduled meeting and the next meeting (if such exists). Allowing longer backup processes when there is a gap.

The certain period and/or the number of backup process iterations may be determined based on a number of people invited to the meeting. A meeting that includes a higher number of people may benefit from a longer backup process and/or from more iterations.

The certain period and/or the number of backup process iterations may be determined based on a seniority and/or other priority of people invited to the meeting. A meeting that includes a people of higher seniority and/or priority may benefit from a longer backup process and/or from more iterations.

If a confirmation is received then jumping to step 208.

If a confirmation is not received during the certain period step 206 is followed by step 210 if determining whether the backup process should be terminated (and the meeting deemed to be cancelled) or not. Step 210 may include checking if enough iterations of the backup process were executed and/or enough time lapsed from the first request. What amount to enough iterations may be determined in advance, may be responsive to the reliability of the meeting initiator, in response to the timing relationship between the current invited meeting and a next meeting, and the like.

If determining not to end the backup process then jumping to step 203. If yes—jumping to step 212 and cancel the meeting—flag the meeting room as vacant.

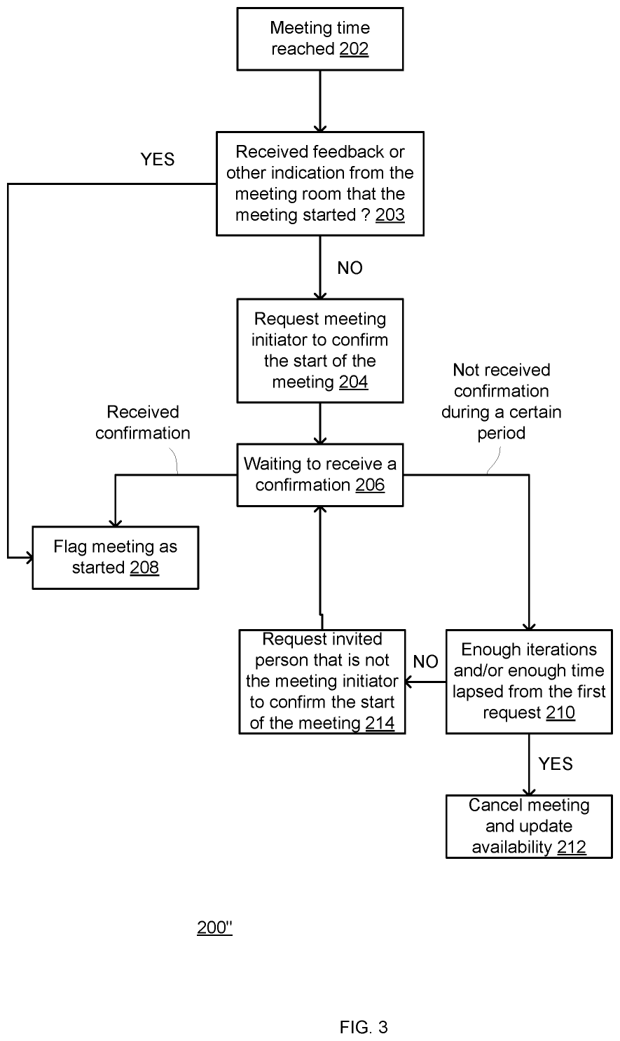

FIG. 3 illustrates an example of method 200″.

Method 200″ may be executed by a system that is a computerized system. The computerized system may include one or more hardware processors and may include communication modules, memory units, and the like.

Method 200″ refers to a single meeting room. It is applicable to multiple meeting rooms.

Method 200″ may start by step 202 of determining that a meeting should begin—meeting time reached.

Step 202 may be followed by step 203 of checking if there is an indication that the meeting begun—check whether the computerized system received feedback or other indication from the meeting room that the meeting started.

If yes—jumping to step 208 of flagging the meeting as started. This may include indicating the the meeting room is occupied by the scheduled meeting.

If no—jumping to step 204 of requesting a meeting initiator (person that reserved the meeting room—or otherwise listed as the meeting initiator) to conform the start of the meeting.

Step 204 may be followed by step 206 of waiting to receive a confirmation 206—for a certain time period.

The certain period may be a fraction of the requested meeting time, a fixed period such as 1, 2, 3, 4, 5 minutes and the like. The certain period may change between one iteration of the backup process to another—for example—may be reduced between one iteration to another.

The certain period may be determined based on a reliability of the meeting initiator—which may be determined based on the number of times meeting that were ordered by the meeting initiator really occurred, the the number of times meeting that were ordered by the meeting initiator did not occur, and the like. The method may be more tolerant to more reliable meeting initiators—and may allow them more time to respond.

The certain period may be determined based on an existence (or lack of existence) of a gap between the scheduled meeting and the next meeting (if such exists).

If a confirmation is received then jumping to step 208.

If a confirmation is not received during the certain period step 206 is followed by step 210 if determining whether the backup process should be terminated (and the meeting deemed to be cancelled) or not. Step 210 may include checking if enough iterations of the backup process were executed and/or enough time lapsed from the first request. What amount to enough iterations may be determined in advance, may be responsive to the reliability of the meeting initiator, in response to the timing relationship between the current invited meeting and a next meeting, and the like.

If determining not to end the backup process then jumping to step 214 and asking an invited person that is not the meeting initiator to confirm the stat of the meeting.

Step 214 is followed by step 206.

If yes—jumping to step 212 and cancel the meeting—flag the meeting room as vacant.

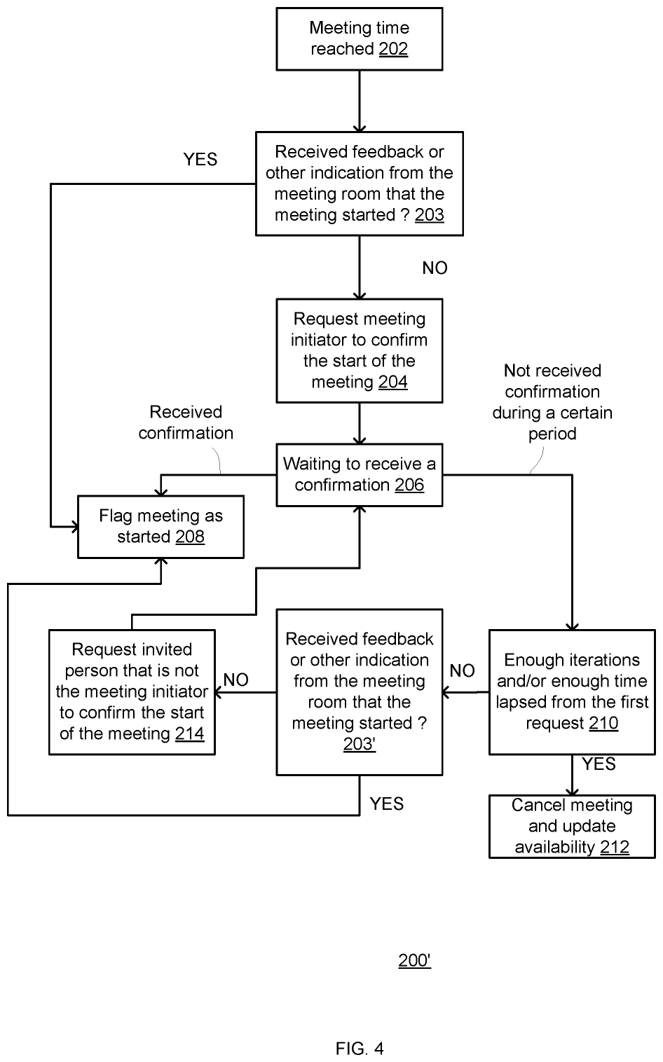

FIG. 4 illustrates an example of method 200′.

Method 200′ may be executed by a system that is a computerized system. The computerized system may include one or more hardware processors and may include communication modules, memory units, and the like.

Method 200′ refers to a single meeting room. It is applicable to multiple meeting rooms.

Method 200′ may start by step 202 of determining that a meeting should begin—meeting time reached.

Step 202 may be followed by step 203 of checking if there is an indication that the meeting begun—check whether the computerized system received feedback or other indication from the meeting room that the meeting started.

If yes—jumping to step 208 of flagging the meeting as started. This may include indicating the the meeting room is occupied by the scheduled meeting.

If no—jumping to step 204 of requesting a meeting initiator (person that reserved the meeting room—or otherwise listed as the meeting initiator) to conform the start of the meeting.

Step 204 may be followed by step 206 of waiting to receive a confirmation 206—for a certain time period.

The certain period may be a fraction of the requested meeting time, a fixed period such as 1, 2, 3, 4, 5 minutes and the like. The certain period may change between one iteration of the backup process to another—for example—may be reduced between one iteration to another.

The certain period may be determined based on a reliability of the meeting initiator—which may be determined based on the number of times meeting that were ordered by the meeting initiator really occurred, the the number of times meeting that were ordered by the meeting initiator did not occur, and the like. The method may be more tolerant to more reliable meeting initiators—and may allow them more time to respond.

The certain period may be determined based on an existence (or lack of existence) of a gap between the scheduled meeting and the next meeting (if such exists).

If a confirmation is received then jumping to step 208.

If a confirmation is not received during the certain period step 206 is followed by step 210 of determining whether the backup process should be terminated (and the meeting deemed to be cancelled) or not.

Step 210 may include checking if enough iterations of the backup process were executed and/or enough time lapsed from the first request. What amount to enough iterations may be determined in advance, may be responsive to the reliability of the meeting initiator, in response to the timing relationship between the current invited meeting and a next meeting, and the like.

If determining not to end the backup process then jumping to step 203′ of checking if there is an indication that the meeting begun—check whether the computerized system received feedback or other indication from the meeting room that the meeting started.

If yes—jumping to step 208 of flagging the meeting as started. This may include indicating the the meeting room is occupied by the scheduled meeting.

If no—jumping to step 214 of asking an invited person that is not the meeting initiator to confirm the stat of the meeting.

Step 214 is followed by step 206.

If yes—jumping to step 212 and cancel the meeting—flag the meeting room as vacant.

It should be noted that the method may include (following step 210) to send a confirmation request to the meeting initiator and to another person.

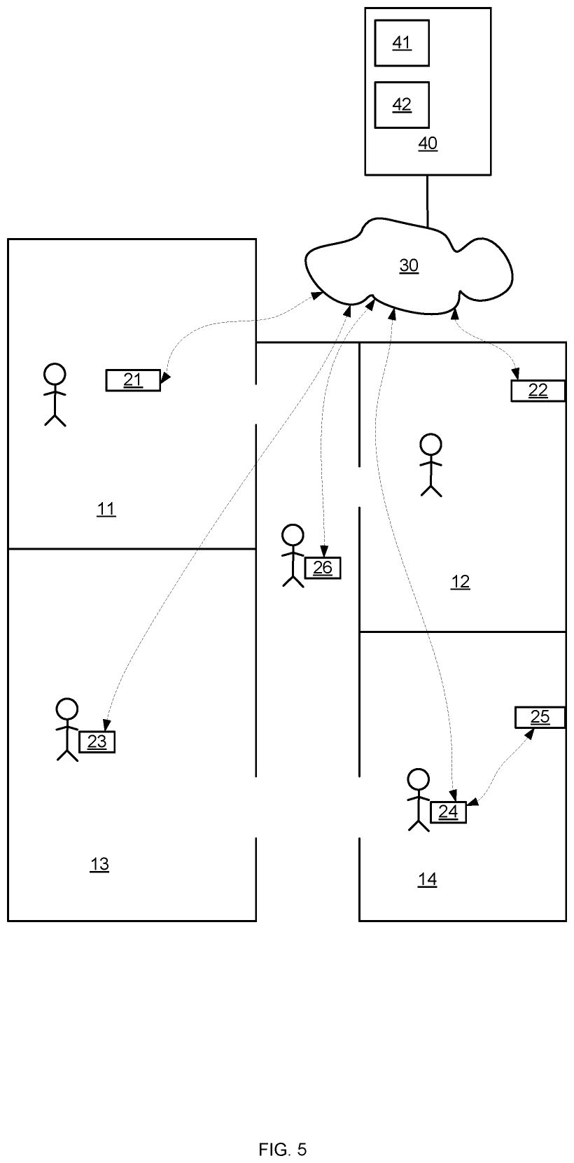

FIG. 5 illustrates an example of meeting rooms, various devices, a network and a system.

Meeting room 11 includes a teleconference device 21. Meeting room 12 includes an audio sensing device such as microphone 22. Meeting room 13 is not equipped with any audio sensing device—but it temporarily includes a user device 23 (such as a smartphone) that is capable of sensing audio. Meeting room 14 includes an audio sensing device such as microphone 25 that is wirelessly coupled to user device 24.

Devices such as teleconference device 21, microphone 22, user device 23 and microphone 25 are used to sense audio signals in meeting rooms 11, 12, 13 and 14 respectively.

The audio signals may be sent directly or indirectly to system 40.

In FIG. 5 network 30 communicates with teleconference device 21, microphone 22, user device 23 and user device 24. Microphone 25 communicated with network 30 through user device 24.

System 40 may include units such as meeting room allocation unit 41 for allocating meeting rooms and meeting room occupancy unit 42 for determining the occupancy of the meeting rooms—and updating meeting room allocation unit unit 41.

Units 41 and 42 may belong to a Microsoft™ Exchange™ server that is configured to manage meeting room reservations and update the availability of meeting rooms, receive requests to reserve meeting rooms and show their status. Units 41 and 42 may be implemented in equivalent services provided by other companies.

The update of the updating meeting room allocation unit 41 is sent to user devices so that users may receive in real time the real state of the meeting rooms.

In FIG. 5 all the meeting rooms are occupied—and user device 26 of a user located in the corridor (and not invited to any of the meeting currently held in meeting rooms 11-14) will not be able to currently book either one of meeting rooms 11-14.

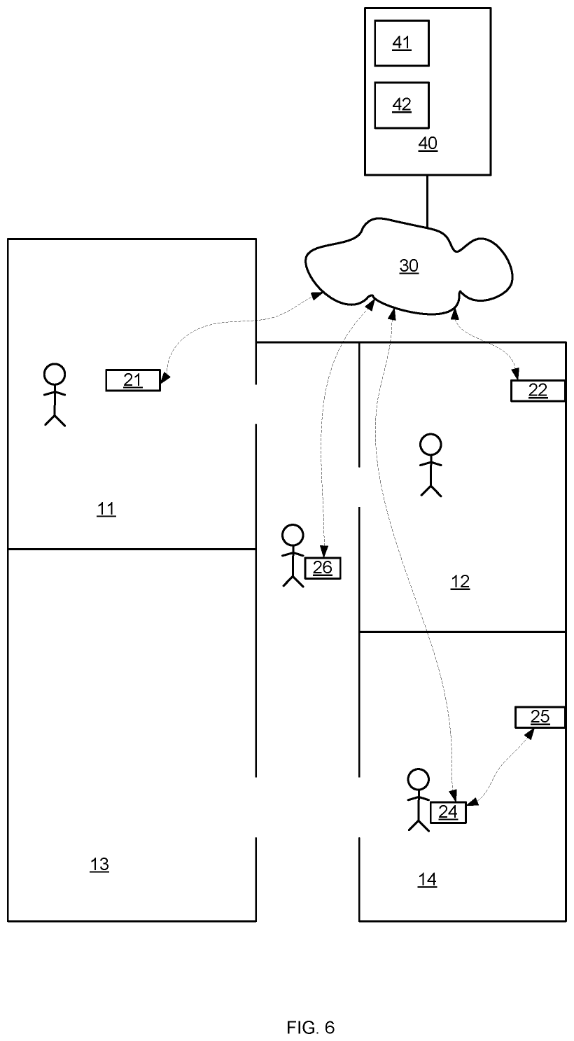

In FIG. 6, meeting room 13 is vacant and user device 26 may receive an indication that meeting room 13 is vacant—even through it is currently booked.

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner. The integrated circuit may be a system on chip, a general-purpose processor, a signal processor, an FPGA, a neural network integrated circuit, and the like.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for determining an occupancy of a meeting room, the method comprises:
receiving or determining, by a computerized system, an allocation of the meeting room to a meeting during a time period;
checking whether audio feedback regarding an actual usage of the meeting room was received at a beginning of the time period;
determining an actual usage of the meeting room based on a reception of the audio feedback or a lack of reception of the audio feedback; and
updating a database and multiple user devices regarding the actual usage of the meeting room.

2. The method according to claim 1 wherein the audio feedback is a keyword.

3. The method according to claim 1 comprising determining a source of audio feedback and ignoring audio feedback originated outside the meeting room.

4. The method according to claim 1 comprising performing at least one iteration of requesting the audio feedback from a meeting initiator, when not receiving the audio feedback at a beginning of the time period.

5. The method according to claim 1 comprising performing up to a certain number of iteration of requesting the audio feedback, when not receiving the audio feedback; and marking the meeting as cancelled after a failure to receive the audio feedback during the certain number of iterations.

6. The method according to claim 5 comprising setting at least one of a time difference between consecutive iterations and the certain number based on a number of persons invited to the meeting.

7. The method according to claim 5 comprising setting at least one of a time difference between consecutive iterations and the certain number based on a priority of persons invited to the meeting.

8. The method according to claim 5 comprising setting at least one of a time difference between consecutive iterations and the certain number based on history of previous meeting room allocations by a meeting initiator that reserved the meeting.

9. The method according to claim 5 comprising setting at least one of a time difference between consecutive iterations and the certain number based on history of previous meeting room allocations by a meeting initiator that reserved the meeting.

10. The method according to claim 5 comprising setting at least one of a time difference between consecutive iterations and the certain number based on an existence or a lack of an existence of a gap between the meeting and a next meeting scheduled in the meeting room.

11. A computer program product that stores instructions that once executed by a computerized system cause the computerized system to perform the steps of:
receiving or determining, by a computerized system, an allocation of a meeting room to a meeting during a time period;
checking whether audio feedback regarding an actual usage of the meeting room was received at a beginning of the time period;
determining an actual usage of the meeting room based on a reception of the audio feedback or a lack of reception of the audio feedback; and
updating a database and multiple user devices regarding the actual usage of the meeting room.

12. The computer program product according to claim 11 wherein the audio feedback is a keyword.

13. The computer program product according to claim 11 that stores instructions for determining a source of audio feedback and ignoring audio feedback originated outside the meeting room.

14. The computer program product according to claim 11 that stores instructions for performing at least one iteration of requesting the audio feedback from a meeting initiator, when not receiving the audio feedback at a beginning of the time period.

15. The computer program product according to claim 11 that stores instructions for performing up to a certain number of iteration of requesting the audio feedback, when not receiving the audio feedback; and marking the meeting as cancelled after a failure to receive the audio feedback during the certain number of iterations.

16. The computer program product according to claim 15 that stores instructions for setting at least one of a time difference between consecutive iterations and the certain number based on a number of persons invited to the meeting.

17. The computer program product according to claim 15 that stores instructions for setting at least one of a time difference between consecutive iterations and the certain number based on a priority of persons invited to the meeting.

18. The computer program product according to claim 15 that stores instructions for setting at least one of a time difference between consecutive iterations and the certain number based on history of previous meeting room allocations by a meeting initiator that reserved the meeting.

19. The computer program product according to claim 15 that stores instructions for setting at least one of a time difference between consecutive iterations and the certain number based on history of previous meeting room allocations by a meeting initiator that reserved the meeting.

20. The computer program product according to claim 15 that stores instructions for setting at least one of a time difference between consecutive iterations and the certain number based on an existence or a lack of an existence of a gap between the meeting and a next meeting scheduled in the meeting room.
